(19) United States
(12) Patent Application Publication
(10) Pub. No.: US 2012/0234302 A1
(43) Pub. Date: Sep. 20, 2012

(54) EVAPORATIVE FUEL TREATMENT APPARATUS OF VEHICLE

(76) Inventors: Takeshi SHIMURA, Wako-shi (JP); Takahiro IMAMURA, Wako-shi (JP)

(21) Appl. No.: 13/397,147

(22) Filed: Feb. 15, 2012

(30) Foreign Application Priority Data
Mar. 16, 2011 (JP) 2011-057563

(51) Int. Cl. F02M 33/02

(52) U.S. Cl. 123/521

(57) ABSTRACT

An evaporative fuel treatment apparatus for a vehicle is provided with a reverse flow preventing valve provided in a fuel supply pipe, a positioning plate provided on the fuel supply pipe, a pressing plate mounted slidably on the fuel supply pipe between the positioning plate the reverse flow preventing valve, a seal member clamped between the positioning plate and the pressing plate, and a stopper. When the fuel supply is started, the reverse flow preventing valve is configured to be set opened so as to form a liquid trap between the reverse flow preventing valve and the pressing plate. When the liquid surface reaches the pressing plate, the fuel pushes the pressing plate upward and the seal member is collapsed in the vertical direction so that the seal member protrudes toward the fuel supply gun insertion holes and makes tight contact with the fuel supply gun to seal a gap.

### CROSS-REFERENCE TO RELATED APPLICATION

The present application claims priority under 35 U.S.C. §119 to Japanese Patent Application No. 2011-057563, filed Mar. 16, 2011. The entire contents of the above-identified application are hereby incorporated by reference.

### BACKGROUND OF THE INVENTION

1. Field of the Invention

The present invention relates to an evaporative fuel treatment apparatus of a vehicle.

2. Description of Background Art

In the related art, at the time of fuel supply to a fuel tank of a vehicle, an evaporative fuel treatment apparatus configured to prevent evaporative fuel in the fuel tank from diffusing from a fuel supply port to the outside and to feed the evaporative fuel to an evaporative fuel storage container is disclosed (for example, see JP-A-8-91062 and JP-UM-A-5-32065).

In JP-A-8-91062, a liquid seal is formed by a liquid trap portion provided at a midsection of a fuel supply pipe to prevent evaporative fuel in a fuel tank from diffusing from a fuel supply port to the outside. In JP-UM-A-5-32065, a seal packing having a lip portion is provided on a fuel supply pipe as a seal member and the lip portion is brought into tight contact with an outer peripheral surface of a fuel supply gun, so that evaporative fuel in a fuel tank is prevented from diffusing from a fuel supply port to the outside.

However, as described in JP-A-8-91062 shown above, a configuration in which the liquid seal is formed by providing the liquid trap portion in the fuel supply pipe can be applied to a passenger vehicle which allows for provision of a long fuel supply pipe, but it is difficult to provide the liquid trap portion on fuel tanks of motorcycles or large trucks or the like in which a fuel supply pipe is short and, in addition, a fuel supply port is provided at a position close to a fuel surface in the full tank condition because the fuel supply port and a liquid trap portion are too close to each other. Also, as described in JP-UM-A-5-32065 shown above, when providing the seal packing on the fuel supply pipe, there are variations in shape of nozzles of the fuel supply guns and, in addition, the fuel guns are inserted or pulled out in a state of being in contact with the seal packing each time fuel is supplied. Therefore, it is an important issue to ensure the sealing property of the seal packing.

In view of such circumstances, it is an object of the present invention to provide an evaporative fuel treatment apparatus for a vehicle in which the sealing property of a seal member is ensured while allowing formation of a liquid seal in the vicinity of a fuel supply port.

### SUMMARY AND OBJECTS OF THE INVENTION

In order to achieve the above-described object, an embodiment of the present invention provides an evaporative fuel treatment apparatus for a vehicle having an internal combustion engine (12), a fuel tank (24) configured to store fuel, an evaporative fuel storage container (51) filled with adsorbent such as activated charcoal in the interior thereof and configured to adsorb and store the evaporative fuel therein, a charge path (52) configured to communicate the fuel tank (24) and the evaporative fuel storage container (51), a purge path (53) configured to communicate the evaporative fuel storage container (51) and an air-intake system (34) of the internal combustion engine (12) and feed the evaporative fuel adsorbed in the evaporative fuel storage container (51) to the air-intake system (34) by depression at engine manifold of the internal combustion engine (12), an atmospheric air opening path (55) configured to communicate the evaporative fuel storage container (51) and the outside, a fuel supply port (41), and a fuel supply pipe (61) which is a cylindrical portion extending from the fuel supply port (41) into the fuel tank (24).

A reverse flow preventing valve (62) is provided at an opening of the fuel supply pipe (61) on the inside of the tank and is a one-way valve which allows the fuel to flow in the fuel supply direction. A positioning plate (63) is provided at an opening of the fuel supply pipe (61) on the side of the fuel supply port and has a fuel supply gun insertion hole (63A). A pressing plate (64) is slidably mounted on the fuel supply pipe (61) between the positioning plate (63) and the reverse flow preventing valve (62) and has a fuel supply gun insertion hole (64A). A seal member (65) is clamped between the positioning plate (63) and the pressing plate (64) and has resiliency, and a stopper (66) is arranged between the pressing plate (64) and the reverse flow preventing valve (62) and is configured to control the amount of insertion of the fuel supply gun (G).

The reverse flow preventing valve (62) is set to be opened so as to form a liquid trap between the reverse flow preventing valve (62) and the pressing plate (64) when the fuel supply is started and, when the liquid surface reaches the pressing plate (64), the fuel pushes the pressing plate (64) upward to collapse the seal member (65) in the vertical direction, and the seal member (65) is protruded toward the fuel supply gun insertion holes (63A, 64A) and is brought into tight contact with the fuel supply gun (G) to seal a gap.

In an embodiment of the present invention, there are provided the reverse flow preventing valve at the opening of the fuel supply pipe, which is the cylindrical portion extending into the fuel tank, on the inside of the tank and configured to allow the fuel to flow in the fuel supply direction, the positioning plate having the fuel supply gun insertion hole, the pressing plate mounted slidably on the fuel supply pipe between the positioning plate and the reverse flow preventing valve and having the fuel supply gun insertion hole, and the seal member clamped between the positioning plate and the pressing plate and having resiliency.

Additionally provided is the stopper arranged between the pressing plate and the reverse flow preventing valve and configured to control the amount of insertion of the fuel supply gun and, when the fuel supply is started, the reverse flow preventing valve is configured to be set opened so as to form the liquid trap between the reverse flow preventing valve and the pressing plate, and when the liquid surface reaches the pressing plate, the fuel pushes the pressing plate upward and the seal member is collapsed in the vertical direction so that the seal member swells toward the fuel supply gun insertion holes and is brought into tight contact with the nozzle of the fuel supply gun to seal the gap, whereby the liquid trap between the reverse flow preventing valve and the pressing plate can be used as a liquid seal even in the vicinity of the fuel supply port by sealing the gap by the seal member which is pushed upward by the liquid surface and hence is collapsed.

Also, since the seal member is brought into tight contact with the fuel supply gun by being collapsed by the liquid surface at the time of fuel supply, and the seal member and the fuel supply gun do not come into sliding contact with each other when inserting or pulling out the fuel supply gun, the sealing property of the seal member can be prevented from being affected by the inserting and pulling-out operation, so that the sealing property of the seal member can be ensured.

In the embodiment of the present invention described above, a fuel supply gun insertion hole (65A) of the seal member (65) may be formed to have a diameter which is equal to or larger than the fuel supply gun insertion hole (63A) of the positioning plate (63).

In this case, since the fuel supply gun insertion hole of the seal member is formed to have a diameter equal to or larger than that of the fuel supply gun insertion hole of the positioning plate, sliding contact of the fuel supply gun with respect to the seal member at the time of the inserting and pulling-out operation of the fuel supply gun can be prevented, and the sealing property of the seal member can be ensured.

Also, in an embodiment of the present invention, the width between the positioning plate (63) and the pressing plate (64) is formed into a tapered shape so as to widen toward the fuel supply gun insertion holes (63A, 64A) and the seal member (65) is formed to be thick along the tapered shape is also applicable.

In this case, the width between the positioning plate and the pressing plate is formed into a tapered shape so as to widen toward the fuel supply gun insertion holes, and the seal member is formed to be thick along the tapered shape, sealing is achieved by the tapered shape by pushing the seal member out toward the fuel supply gun, so that the sealing property can further be improved.

Furthermore, in an embodiment of the present invention, the seal member (65) has a sponge form, and the pressing plate (64) includes a through hole (64B) which penetrates in the vertical direction separately from the fuel supply gun insertion hole (64A) is also applicable.

In this case, since the seal member has a sponge form and the pressing plate has the through hole which penetrates in the vertical direction separately from the fuel supply gun insertion hole, so that the fuel flows from the through hole toward the seal member and is contained in the seal member of a sponge form, whereby the sealing property can further be improved.

Also, the fuel supply gun (G) may include an automatic stop detecting unit (G2) which is a pressure sensing hole, and the stopper (66) may be arranged so that the automatic stop detecting unit (G2) is located above the positioning plate (63) when the fuel supply gun is inserted.

In this case, since the stopper is arranged so that the automatic stop detecting unit of the fuel supply gun is located above the positioning plate when the fuel supply gun is inserted, the automatic stop detecting unit can be activated even with a configuration in which the liquid seal is formed below the positioning plate. Also, even when there arises a problem in the seal member and the fuel is leaked up, the fuel supply can be stopped by the automatic stop detecting unit and the flow-out of the fuel to the outside can be prevented.

Also, in an embodiment of the present invention a cut valve (56) is provided in a charge path (52) in the fuel tank (24) and is configured to close the charge path (52) in a full tank condition, a fuel return pipe (73) is configured to communicate the interior of the fuel tank (24) and the fuel supply pipe (61) above the positioning plate (63), and a return pipe opening and closing valve (74) which is a float valve to be arranged in the fuel return pipe (73) in the fuel tank (24). The return pipe opening and closing valve (74) is opened in the full tank condition to feed the fuel to the automatic stop portion (G2) above the positioning plate (63) is also applicable.

In this case, there are provided the cut valve configured to close the charge path in the full tank condition, the fuel return pipe configured to communicate the interior of the fuel tank and the fuel supply pipe above the positioning plate, and the return pipe opening and closing valve arranged in the fuel return pipe in the fuel tank, and the return pipe opening and closing valve opens in the full tank condition and feeds the fuel to the automatic stop portion above the positioning plate. Therefore, even with a configuration in which the liquid surface cannot be viewed due to the presence of the liquid seal, the fuel is fed from the fuel return pipe to the automatic stop portion in the full tank condition and hence the fuel supply can be stopped automatically in the full tank condition.

An embodiment of the present invention also provides an evaporative fuel treatment apparatus for a vehicle having an internal combustion engine (12), a fuel tank (24) configured to store fuel, an evaporative fuel storage container (51) filled with adsorbent such as activated charcoal in the interior thereof and configured to adsorb and store the evaporative fuel therein, a charge path (52) configured to communicate the fuel tank (24) and the evaporative fuel storage container (51), a purge path (53) configured to communicate the evaporative fuel storage container (51) and an air-intake system (34) of the internal combustion engine (12) and feed the evaporative fuel adsorbed in the evaporative fuel storage container (51) to the air-intake system (34) by depression at engine manifold of the internal combustion engine (12), an atmospheric air opening path (55) configured to communicate the evaporative fuel storage container (51) and the outside, a fuel supply port (41), a fuel supply pipe (61) which is a cylindrical portion extending from the fuel supply port (41) into the fuel tank (24).

In this embodiment of the present invention, a reverse flow preventing valve (62) is provided at an opening of the fuel supply pipe (61) on the inside of the tank and being a one-way valve which allows the fuel to flow in the fuel supply direction. A positioning plate (63) is provided at an opening of the fuel supply pipe (61) on the side of the fuel supply port and having a fuel supply gun insertion hole (63A). A lower plate (264) is fixed to the fuel supply pipe (61) between the positioning plate (63) and the reverse flow preventing valve (62) and having a fuel supply gun insertion hole (264A). A bag-shaped seal member (265) is clamped between the positioning plate (63) and the lower plate (264) and configured to communicate with a liquid seal chamber (L2) by the communicating portion (264B), and a stopper (66) is arranged between a lower plate (264) and the reverse flow preventing valve (62) and configured to control the amount of insertion of the fuel supply gun (G). The reverse flow preventing valve (62) is set to be opened so as to form a liquid trap in the liquid seal chamber (L2) between the reverse flow preventing valve (62) and the lower plate (264) when the fuel supply is started and, when the liquid surface reaches the lower plate (264), the fuel enters the seal member (265) from the communicating portion (264B), and the seal member (265) is protruded toward the fuel supply gun insertion holes (63A, 264A) and is brought into tight contact with the fuel supply gun (G) to seal a gap.

In this configuration, there are provided the reverse flow preventing valve at the opening of the fuel supply pipe, which is the cylindrical portion extending into the fuel tank, on the inside of the tank and configured to allow the fuel to flow in the fuel supply direction, the positioning plate provided at the opening of the fuel supply pipe on the side of the fuel supply port and having the fuel supply gun insertion hole, the lower plate fixed on the fuel supply pipe between the positioning plate and the reverse flow preventing valve and having the fuel supply gun insertion hole, the bag-shaped seal member clamped between the positioning plate and the lower plate and configured to communicate with the liquid seal chamber by the communicating portion, and the stopper arranged between the lower plate and the reverse flow preventing valve and configured to control the amount of insertion of the fuel supply gun and, when the fuel supply is started, the reverse flow preventing valve is configured to be set opened so as to form the liquid trap in the liquid seal chamber between the reverse flow preventing valve and the lower plate, and when the liquid surface reaches the lower plate, the fuel enters the seal member from the communicating portion so that the seal member protrudes toward the fuel supply gun insertion holes and is brought into tight contact with the fuel supply gun to seal the gap, whereby the liquid trap between the reverse flow preventing valve and the lower plate can be used as a liquid seal even in the vicinity of the fuel supply port by sealing the gap by the seal member which is protruded by the entry of the fuel reaching the lower plate.

Also, since the seal member is brought into tight contact with the fuel supply gun by the entry of the fuel at the time of fuel supply, and the seal member and the fuel supply gun do not come into sliding contact with each other when inserting or pulling out the fuel supply gun, the sealing property of the seal member can be prevented from being affected by the inserting and pulling-out operation, so that the sealing property of the seal member can be ensured.

Advantages of the present invention include:

According to the evaporative fuel treatment apparatus for a vehicle in an embodiment of the present invention, the fuel push the pressing plate upward and hence the seal member is collapsed in the vertical direction, whereby the seal member is protruded toward the fuel supply gun insertion hole and is brought into tight contact with the fuel supply gun to seal the gap. Therefore, the gap is sealed by the seal member pushed upward by the liquid surface and collapsed thereby, and hence the liquid trap between the reverse flow preventing valve and the pressing plate can be used as the liquid seal even in the vicinity of the fuel supply port. Also, since the seal member is brought into tight contact with the fuel supply gun by being collapsed by the liquid surface at the time of fuel supply, and the seal member and the fuel supply gun do not come into sliding contact with each other when inserting or pulling out the fuel supply gun, the sealing property of the seal member can be prevented from being affected by the inserting and pulling-out operation, so that the sealing property of the seal member can be ensured.

Also, since the fuel supply gun insertion hole of the seal member is formed to have a diameter equal to or larger than that of the fuel supply gun insertion hole of the positioning plate, sliding contact of the fuel supply gun with respect to the seal member at the time of the inserting and pulling-out operation of the fuel supply gun can be prevented, and the sealing property of the seal member can be ensured.

Since the sealing member is formed to be thick along the tapered shape between the positioning plate and the pressing plate, sealing is achieved by the tapered shape by pushing the seal member out toward the fuel supply gun, so that the sealing property can further be improved.

In addition, since the seal member has a sponge form and the fuel flows from the through hole toward the seal member and is contained in the seal member of a sponge form, whereby the sealing property can further be improved.

Furthermore, since the stopper is arranged so that the automatic stop detecting unit of the fuel supply gun is located above the positioning plate when the fuel supply gun is inserted, the automatic stop detecting unit can be activated even with a configuration in which the liquid seal is formed below the positioning plate. Also, even when there arises a problem in the seal member and the fuel is leaked up, the fuel supply can be stopped by the automatic stop detecting unit and the flow-out of the fuel to the outside can be prevented.

The return pipe opening and closing valve opens in the full tank condition and feeds the fuel to the automatic stop portion above the positioning plate. Therefore, even with a configuration in which the liquid surface cannot be viewed due to the presence of the liquid seal, the fuel is fed from the fuel return pipe to the automatic stop portion in the full tank condition and hence the fuel supply can be stopped automatically in the full tank condition.

Also, according to the evaporative fuel treatment apparatus for a vehicle in an embodiment of the present invention, since the seal member is protruded toward the fuel supply gun insertion hole and is brought into tight contact with the fuel supply gun to seal the gap by the entry of the fuel from the communicating portion into the seal member when the liquid level reaches the lower plate, the gap is sealed by the seal member which is protruded by the entry of the fuel reaching the lower plate, so that the liquid trap between the reverse flow preventing valve and the lower plate can be used as the liquid seal even in the vicinity of the fuel supply port. Also, since the seal member is brought into tight contact with the fuel supply gun by the entry of the fuel at the time of fuel supply, and the seal member and the fuel supply gun do not come into sliding contact with each other when inserting or pulling out the fuel supply gun, the sealing property of the seal member can be prevented from being affected by the inserting and pulling-out operation, so that the sealing property of the seal member can be ensured.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a left side view of a motorcycle according to an embodiment of the present invention;

FIG. 2 is a cross-sectional view showing a fuel tank and the periphery thereof;

FIG. 3 is a drawing showing a configuration of an evaporative fuel treatment apparatus;

FIG. 4 is a cross-sectional view of a seal mechanism;

FIG. 5 is a cross-sectional view of the seal mechanism at the time of fuel supply; and.

FIG. 6 is a cross-sectional view showing a configuration of a seal mechanism according to a second embodiment.

### DETAILED DESCRIPTION OF THE PREFERRED EMBODIMENTS

Referring now to the drawings, an evaporative fuel treatment apparatus for a vehicle according to embodiments of the present invention will be described. In the following description, directions such as up, down, front, rear, left, and right indicates directions viewed from a driver of the vehicle.

### First Embodiment

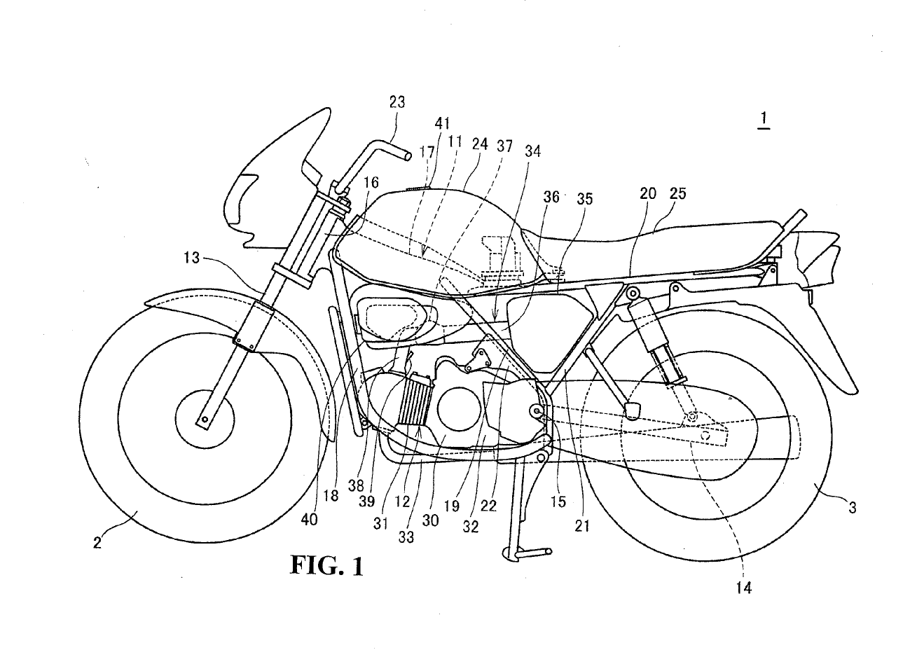

FIG. 1 is a left side view of a motorcycle according to an embodiment of the present invention.

A motorcycle 1 (vehicle) is a saddle-type vehicle including an engine 12 (internal combustion engine) arranged at a center of a vehicle body frame 11 in the fore-and-aft direction, front forks 13 configured to support a front wheel 2 supported at a front end of the vehicle body frame 11 so as to be steerable, and a rear swing arm 14 configured to support a rear wheel 3 and provided at a lower rear portion of the vehicle body frame 11.

The vehicle body frame 11 includes a head pipe 16 configured to support a pair of the left and right front forks 13 so as to be steerable, a main frame 17 extending rearward and downward from a rear portion of the head pipe 16, a pair of left and right down frames 18 extending rearward and downward from a lower portion of the head pipe 16, a pair of left and right center frames 19 extending downward from a rear portion of the main frame 17, a pair of left and right seat rails 20 extending from the rear portion of the main frame 17 to a rear portion of the vehicle, and a pair of left and right sub-pipes 21 extending rearward and upward from the center frames 19 and coupled to the respective seat rails 20. The center frames 19 are each provided with a pivot plate 22 configured to support the rear swing arm 14.

The pivot plate 22 is provided with a pivot shaft 15 penetrating through the pivot plate 22 in the vehicle width direction, and the rear swing arm 14 is supported by the pivot shaft 15.

A steering handle 23 is mounted on an upper portion of the front forks 13, and the front wheel 2 is supported at a lower portion of the front forks 13 via a shaft. A fuel tank 24 configured to store fuel to be supplied to the engine 12 is arranged so as to straddle the main frame 17. A storage box 40 is provided below the fuel tank 24.

A passenger's seat 25 provided so as to straddle the left and right seat rails 20 is arranged above the seat rails 20 so as to continue from a rear end of the fuel tank 24, and extends rearward along the seat rails 20.

The engine 12 includes a crank case 30 in which a crankshaft (not shown) extending in the vehicle width direction is accommodated, and a cylinder 31 extending forward from a front portion of the crank case 30. A transmission 32 is integrally provided at a rear portion of the crank case 30.

An exhaust pipe 33 is connected to a front portion of the cylinder 31, and the exhaust pipe 33 extends from the front of the crank case 30 and then the underside thereof rightward and rearward of the vehicle.

Provided between the fuel tank 24 and the engine 12 is an air-intake apparatus 34 (air-intake system) configured to supply air and fuel to the engine 12. The air-intake apparatus 34 includes an air cleaner box 35 provided on the underside of a rear portion of the fuel tank 24 and configured to suck outside air, a connecting tube 36 configured to extend forward from the air cleaner box 35, a throttle body 37 configured to be connected to a front end of the connecting tube 36, an air-intake pipe 38 extending downward from the throttle body 37 and connected to an air-intake port of the engine 12, and an injector 39 configured to eject fuel to the air-intake pipe 38.

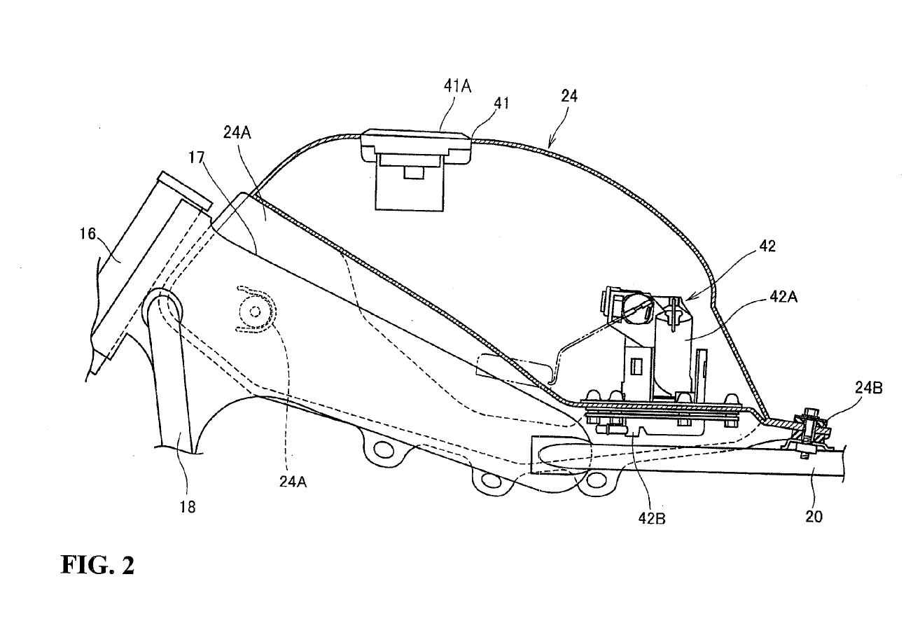

FIG. 2 is a cross-sectional view showing the fuel tank 24 and the periphery thereof.

The fuel tank 24 is a saddle-type tank provided so as to straddle the main frame 17, and includes straddle portions 24A protruding along left and right side surfaces of the main frame 17, and is fixed to the vehicle body frame 11 via the straddle portions 24A provided on the left and right straddle portions 24A, and a rear fixed portion 24B provided at the rear portion.

The fuel tank 24 includes a fuel supply port 41 which serves as an inlet port of fuel at the time of fuel supply, and a fuel pump 42 configured to pump out fuel to the injector 39 on a bottom portion of the rear portion in the fuel tank 24. Attached on an upper surface of the fuel supply port 41 is an openable and closable filler cap 41A. The fuel pump 42 includes a pump body 42A provided in the fuel tank 24 and a connecting portion 42B exposed from a lower surface of the fuel tank 24, and a fuel hose (not shown) which leads to the injector 39 is connected to the connecting portion 42B.

An evaporative fuel treatment apparatus 50 configured to store evaporative fuel in the fuel tank 24 temporarily and supply the same to the engine 12 for combustion is connected to the fuel tank 24.

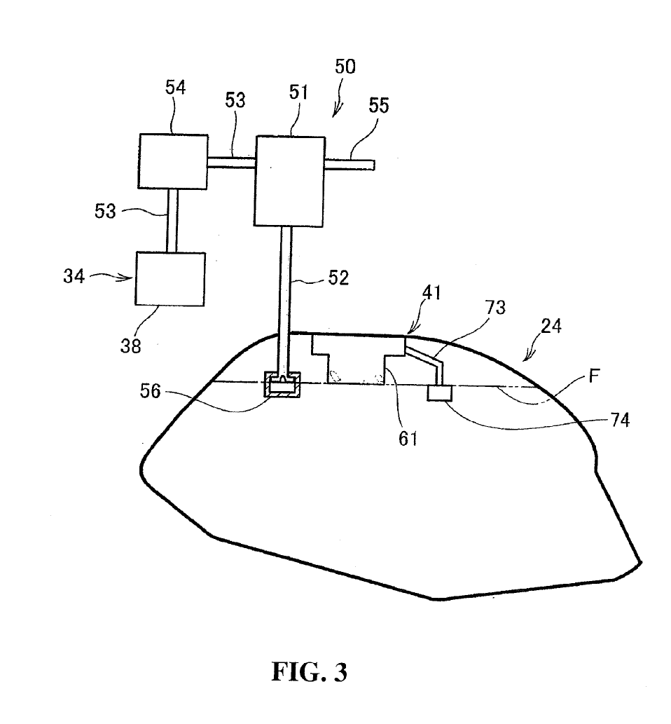

FIG. 3 is a drawing showing a configuration of the evaporative fuel treatment apparatus 50.

The evaporative fuel treatment apparatus 50 is a system which causes HC (Hydrocarbon) as a component of the evaporative fuel in the fuel tank 24 to be adsorbed once to a cylindrical canister 51 (evaporative fuel storage container), supplies the adsorbed evaporative fuel to an air intake system of the engine 12 using a negative pressure of the intake air of the engine 12 so as to be burned together with air-fuel mixture, and this system can prevent the evaporative fuel from being dispersed to the outside.

The evaporative fuel treatment apparatus 50 includes a charge path 52 provided in the fuel tank 24 at one end thereof and connected to the canister 51 at the other end thereof, the canister 51 filled with adsorbent such as activated charcoal in the interior thereof and configured to store the evaporative fuel therein, a purge path 53 connected at one end thereof to the canister 51 and at the other end thereof to the air-intake pipe 38 of the air-intake apparatus 34 of the engine 12, a purge control valve 54 provided at a midsection of the purge path 53, and an atmospheric air opening path 55 communicated with the outside of the canister 51. The purge control valve 54 is a one-way valve configured to control timing of feeding the evaporative fuel toward the air-intake pipe 38, and is controlled to open and close by a controller (not shown) mounted on the vehicle. Attached at an end in the fuel tank 24 of the charge path 52 is a cut valve 56 configured to close the charge path 52 when the fuel tank 24 is in the full tank condition. The cut valve 56 is a float valve configured to close by rising of a fuel level. The cut valve 56 is opened when the fuel level is lower than the level in the full tank condition, and the fuel tank 24 communicates with the canister 51.

When part of the fuel in the fuel tank 24 is evaporated and the internal pressure of the fuel tank 24 is increased, the evaporative fuel flows through the charge path 52 into the canister 51, and is adsorbed once into the canister 51. Then, when the purge control valve 54 is controlled to an opened state, the canister 51 and the air-intake pipe 38 communicate with each other, and flow of the evaporative fuel from the canister 51 to the air-intake pipe 38 of the engine 12 is allowed. When the negative pressure of the intake air of the engine 12 acts at a predetermined value or higher, the evaporative fuel flows from the canister 51 into the engine 12, and is burned in the engine 12. When the interior of the canister 51 is brought into the negative pressure, outside air is introduced from the atmospheric air opening path 55 into the canister 51.

The evaporative fuel treatment apparatus 50 in the first embodiment includes a seal mechanism 60 configured to seal the fuel supply port 41 to prevent the evaporative fuel in the fuel tank 24 from flowing out from the fuel supply port 41 to the outside at the time of fuel supply.

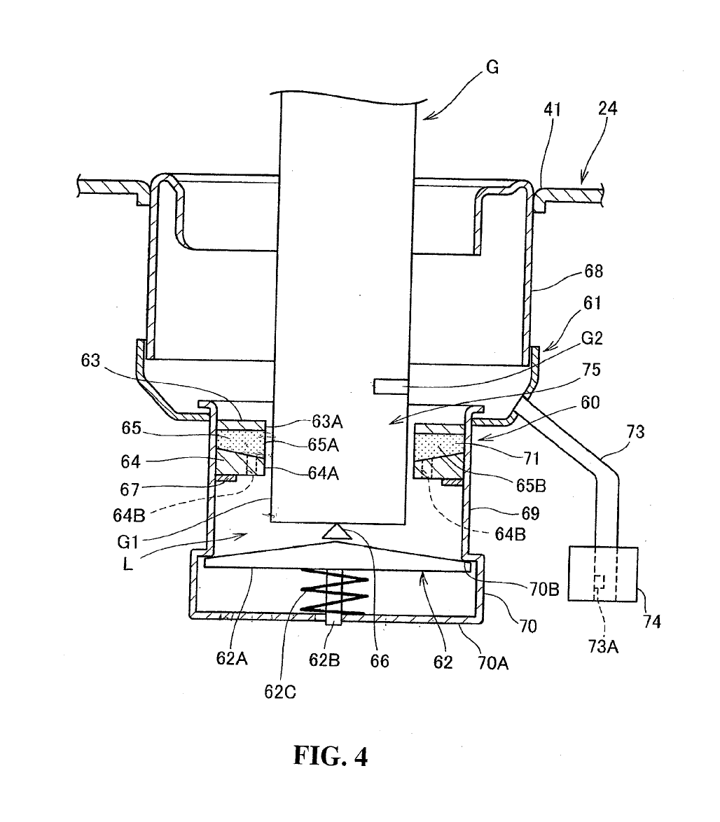

FIG. 4 is a cross-sectional view of the seal mechanism 60.

The seal mechanism 60 includes a fuel supply pipe 61 which is a cylindrical portion extending in the vertical direction from the fuel supply port 41 into the fuel tank 24, a reverse flow preventing valve 62, which is a one-way valve provided at an opening at a lower portion of the fuel supply pipe 61 in the fuel tank 24 and configured to allow the flow in the direction of fuel supply, a positioning plate 63 provided at an opening on the side of the fuel supply port 41 of the fuel supply pipe 61, a pressing plate 64 provided in the fuel supply pipe 61 between the positioning plate 63 and the reverse flow preventing valve 62 so as to be capable of sliding freely, a seal member 65 clamped between the positioning plate 63 and the pressing plate 64, a stopper 66 arranged between the pressing plate 64 and the reverse flow preventing valve 62, and a supporting portion 67 configured to support the pressing plate 64 from below.

The fuel supply pipe 61 is a cylinder which allows insertion of a nozzle G1 of a fuel supply gun G provided in gas stations, and includes an upper fuel supply pipe 68 to be fixed to the peripheral edge portion of the fuel supply port 41 and a lower fuel supply pipe 69 formed to have a diameter smaller than the upper fuel supply pipe 68, fitted to a bottom portion of the upper fuel supply pipe 68 and extending downward. The lower fuel supply pipe 69 includes an enlarged-diameter portion 70 having a diameter larger than that of an upper portion thereof, and the enlarged-diameter portion 70 includes a bottom surface portion 70A provided so as to close an opening of the lower fuel supply pipe 69. Formed on the enlarged-diameter portion 70 and the bottom surface portion 70A are a plurality of openings (not shown) which allow passage of the fuel.

The reverse flow preventing valve 62 is provided on the enlarged-diameter portion 70 of the lower fuel supply pipe 69, and includes a valve body 62A which is slidable in the vertical direction in the enlarged-diameter portion 70, a shaft portion 62B provided at a center of the valve body 62A and allows to be slidably inserted through the bottom surface portion 70A, and a valve spring 62C fitted on the shaft portion 62B to urge the valve body 62A in the closing direction. The valve body 62A is pressed by the valve spring 62C so as to come into abutment with a shoulder portion 70B formed on an upper portion of the enlarged-diameter portion 70, and prevents liquid fuel and evaporative fuel from flowing out to the outside from the interior of the fuel tank 24 by closing the fuel supply pipe 61.

The reverse flow preventing valve 62 is opened by the valve body 62A displaced downward by contraction of the valve spring 62C when a predetermined pressure is applied on the upper surface of the valve body 62A. When the reverse flow preventing valve 62 is opened, fuel supplied from the nozzle G1 passes through the reverse flow preventing valve 62, the enlarged-diameter portion 70, and the bottom surface portion 70A and is capable of flowing into the fuel tank 24.

The positioning plate 63 is a disk-shaped member to be fixed to the upper portion of the lower fuel supply pipe 69, and has a fuel supply gun insertion hole 63A which allows insertion of the nozzle G1 at a center portion thereof. The nozzle G1 is radially positioned by being inserted into the fuel supply gun insertion hole 63A.

The pressing plate 64 is a disk-shaped member to be arranged below the positioning plate 63 in the lower fuel supply pipe 69, and has a fuel supply gun insertion hole 64A which allows insertion of the nozzle G1 at a center portion thereof. The pressing plate 64 is supported by the supporting portion 67 provided in the lower fuel supply pipe 69 from below, and is movable in the vertical direction along an inner surface of the lower fuel supply pipe 69.

An upper surface of the pressing plate 64 is formed obliquely so that the thickness is reduced toward the inner peripheral side, and a tapered storage portion 71 formed into a tapered shape having a width widening toward the fuel supply gun insertion holes 63A, 64A is provided between the positioning plate 63 and the pressing plate 64.

The pressing plate 64 is formed with a through hole 64B penetrating through the pressing plate 64 in the vertical direction and in the direction of the thickness thereof.

A space between the pressing plate 64 and the reverse flow preventing valve 62 in the lower fuel supply pipe 69 is a liquid seal chamber L in which a liquid seal (a liquid trap) is formed by the fuel flowing from the nozzle G1 trapped temporarily therein. An urging force of the valve spring 62C and the shape of the valve body 62A are set so that the reverse flow preventing valve 62 assumes a valve opening which allows formation of a liquid seal in the liquid seal chamber L at the time of fuel supply. Since the evaporative fuel in the fuel tank 24 is prevented from passing through the fuel supply pipe 61 by the formation of the liquid seal in the liquid seal chamber L, the evaporative fuel is prevented from flowing out to the outside from the fuel supply pipe 61 at the time of fuel supply.

The seal member 65 is a disk-shaped member to be arranged between the positioning plate 63 and the pressing plate 64 in the lower fuel supply pipe 69, and has a fuel supply gun insertion hole 65A which allows insertion of the nozzle G1 at a center portion thereof. The fuel supply gun insertion hole 65A of the seal member 65 is formed to have a diameter larger than that of the fuel supply gun insertion hole 63A of the positioning plate 63, so that the nozzle G1 is prevented from coming into sliding contact with the fuel supply gun insertion hole 65A when inserting or pulling the nozzle G1 in or out of the fuel supply port 41. The seal member 65 also has a tapered portion 65B having a tapered shape which is increased in thickness toward the fuel supply gun insertion hole 65A. The tapered portion 65B is formed so as to match the width of the tapered storage portion 71. A fuel supply gun insertion hole 75 which allows insertion of the nozzle G1 is formed by communication of the fuel supply gun insertion holes 65A, 63A, and 64A.

The seal member 65 is formed of rubber being resistant against oil and having a sponge form, and is a porous resilient member. Therefore, the seal member 65 is reduced in thickness and is deformed so as to be protruded radially inward when pressed by the pressing plate 64 from below, and an inner peripheral surface of the fuel supply gun insertion hole 65A is brought into abutment with an outer peripheral surface of the nozzle G1. Since the seal member 65 is crushed when the tapered portion 65B is pressed by the tapered storage portion 71, the amount of deformation of the seal member 65 toward the fuel supply gun insertion hole 65A is increased, so that the seal member 65 can be reliably brought into tight contact with the nozzle G1.

The stopper 66 is a rod-shaped member provided so as to be bridged in the radial direction in the lower fuel supply pipe 69, is provided below the fuel supply gun insertion hole 64A and above the reverse flow preventing valve 62, and controls the amount of insertion of the nozzle G1 by coming into abutment with a distal end of the nozzle G1.

The fuel supply gun G includes an automatic stop detecting unit G2 (automatic stop portion) at a position moved from the distal end of the nozzle G1 toward the proximal side by a predetermined distance. The automatic stop detecting unit G2 is a pressure sensing hole sensing the pressure in the vicinity of the automatic stop detecting unit G2. When fuel enters the automatic stop detecting unit G2, the pressure in the interior of the automatic stop detecting unit G2 is changed, whereby the diaphragm in the fuel supply gun G is activated and the fuel supply gun G stops the fuel supply automatically. In other words, the fuel level in the fuel tank 24 rises, and when the fuel level reaches the position of the automatic stop detecting unit G2, the fuel supply is automatically stopped.

The stopper 66 is arranged at a position where the position of the nozzle G1 can be controlled so that the automatic stop detecting unit G2 is positioned in the upper fuel supply pipe 68 above the positioning plate 63.

A fuel return pipe 73 is provided in the upper fuel supply pipe 68. The fuel return pipe 73 brings the interior of the fuel tank 24 below the upper fuel supply pipe 68 and the interior of the fuel supply pipe 61 above the positioning plate 63 into communication. Provided at a lower end of the fuel return pipe 73 is a return pipe opening and closing valve 74 as a float valve. More specifically, the fuel return pipe 73 includes an opening 73A on an outer peripheral surface of a lower end portion, and the return pipe opening and closing valve 74 is provided so as to be slidably inserted into the fuel return pipe 73 and close the opening 73A. The fuel level in the fuel tank 24 rises and reaches a position in the vicinity of the return pipe opening and closing valve 74, the return pipe opening and closing valve 74 pushed upward by buoyancy moves upward, exposes the opening 73A into the fuel tank 24, so that a valve-open position is achieved, and hence the interior of the fuel tank 24 communicates with the upper fuel supply pipe 68.

As shown in FIG. 3, the return pipe opening and closing valve 74 and the cut valve 56 are provided at the substantially same level, and the return pipe opening and closing valve 74 and the cut valve 56 are activated when the fuel reaches a full level F. In other words, when the fuel level reaches the liquid level F in the full tank condition, the charge path 52 is closed with the cut valve 56 closed, and the interior of the fuel tank 24 communicates with the upper fuel supply pipe 68 with the return pipe opening and closing valve 74 opened, and part of the fuel in the fuel tank 24 is pushed by an internal pressure raised by the fuel supply and flows through the fuel return pipe 73 to the upper fuel supply pipe 68.

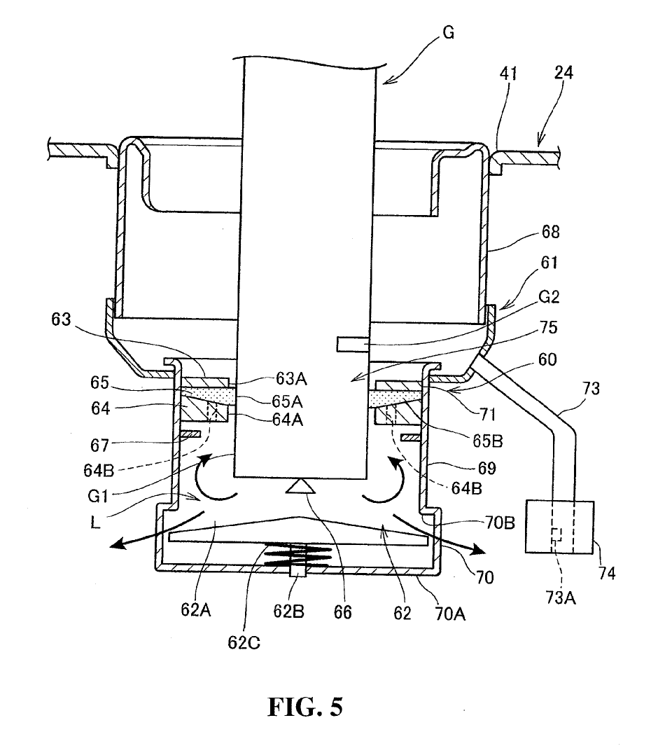

FIG. 5 is a cross-sectional view of the seal mechanism 60 at the time of fuel supply.

As shown in FIG. 4, the nozzle G1 is inserted downward while being positioned in the radial direction by the positioning plate 63 in association with the fuel supply, and the distal end thereof is brought into abutment with the stopper 66, whereby the position in the vertical direction is restricted. In this state, the automatic stop detecting unit G2 is positioned on a lower portion of the upper fuel supply pipe 68 above the positioning plate 63. Here, the fuel supply gun insertion hole 65A of the seal member 65 is formed to have a diameter larger than the fuel supply gun insertion hole 63A of the positioning plate 63, and hence the fuel supply gun insertion hole 65A is prevented from coming into sliding contact with scratches or rough surface of the nozzle G1 when inserting or pulling the nozzle G1 in or out of the positioning plate 63, so that the sealing property of the seal member 65 can be ensured.

When the fuel supply from the nozzle G1 is started, as shown in FIG. 5, the reverse flow preventing valve 62 is opened by a predetermined opening by the pressure of the fuel supply from the nozzle G1, and the supplied fuel forms a liquid seal by temporarily trapped in the liquid seal chamber L and is flowed into the fuel tank 24. More specifically, the supplied fuel passes through the reverse flow preventing valve 62 in sequence and flowed into the fuel tank 24 while forming a convection current which reaches a lower surface of the pressing plate 64 in the liquid seal chamber L as indicated by arrows. In this case, the pressing plate 64 is pushed upward by the fuel being trapped in the liquid seal chamber L and, consequently, the seal member 65 is collapsed in the vertical direction between the pressing plate 64 and the positioning plate 63 and hence is protruded toward the fuel supply gun insertion hole 65A, and the inner peripheral surface of the fuel supply gun insertion hole 65A comes into tight contact with the outer peripheral surface of the nozzle G1, whereby a gap between the nozzle G1 and the fuel supply gun insertion hole 65A is sealed. The evaporative fuel generated at the time of fuel supply flows to the canister 51 through the cut valve 56 (FIG. 3) and the charge path 52 and is adsorbed.

In this manner, the liquid seal is formed in the liquid seal chamber L in association with the start of the fuel supply, and an upper portion of the liquid seal chamber L is sealed by the seal member 65 which is deformed by the rise of the liquid surface, so that the liquid seal can be formed even in the vicinity of the fuel supply port 41. Therefore, the liquid seal can be provided in the vicinity of the fuel supply port 41 even at the fuel supply port 41 of the fuel tank 24 of the motorcycle, in which a long fuel supply pipe can hardly be provided.

In addition, at the time of fuel supply, a small amount of fuel flows to the seal member 65 through the through hole 64B formed on the pressing plate 64, and the fuel is soaked into the seal member 65 in the state of a sponge, and a porous portion of the seal member 65 is clogged by the fuel. Therefore, the sealing property of the seal member 65 is further improved.

Subsequently, when the fuel level in the fuel tank 24 reaches the full level F in association with the fuel supply, the liquid surface in this full level F closes the cut valve 56 and opens the return pipe opening and closing valve 74, and part of the fuel is pushed by the internal pressure of the fuel tank 24 increased by the fuel supply, flows in the fuel return pipe 73, and reaches the upper fuel supply pipe 68. The fuel having reached the upper fuel supply pipe 68 flows to the automatic stop detecting unit G2 of the nozzle G1 positioned at the upper fuel supply pipe 68 by the stopper 66 and the fuel supply is stopped automatically by the fuel supply gun G. In a configuration in which the liquid seal is formed in the fuel supply pipe 61, it is difficult to view the fuel surface in the full level F from the fuel supply port 41, and it is difficult for a person who supplies fuel to stop the fuel supply by confirming the fuel level. However, as in the first embodiment, the fuel supply can be stopped automatically in the full tank condition by positioning the automatic stop detecting unit G2 at the upper fuel supply pipe 68 by the stopper 66 and providing the fuel return pipe 73 communicating with the upper fuel supply pipe 68 in the full tank condition. When the fuel supply is stopped, the pressing plate 64 is moved downward and the deformation of the seal member 65 is released, and the fuel supply gun insertion hole 65A becomes larger than the fuel supply gun insertion hole 63A. Therefore, sliding contact of the nozzle G1 with the fuel supply gun insertion hole 65A of the seal member 65 when pulling out the nozzle G1 can be prevented.

As described thus far, according to the first embodiment of the present invention, there are provided the reverse flow preventing valve 62 which allows an opening of the fuel supply pipe 61, which is a cylindrical portion extending into the fuel tank 24, on the inside of the tank and configured to allow the fuel to flow in the fuel supply direction, the positioning plate 63 having the fuel supply gun insertion hole 63A, the pressing plate 64 mounted slidably on the fuel supply pipe 61 between the positioning plate 63 and the reverse flow preventing valve 62 and having the fuel supply gun insertion hole 64A, the seal member 65 clamped between the positioning plate 63 and the pressing plate 64 and having resiliency, and the stopper 66 arranged between the pressing plate 64 and the reverse flow preventing valve 62 and controls the amount of insertion of the fuel supply gun G and, when the fuel supply is started, the reverse flow preventing valve 62 is configured to be set opened so as to form the liquid trap between the reverse flow preventing valve 62 and the pressing plate 64, and when the liquid surface reaches the pressing plate 64, the fuel pushes the pressing plate 64 upward and the seal member 65 is collapsed in the vertical direction so that the seal member 65 protrudes toward the fuel supply gun insertion holes 63A, 64A and is brought into tight contact with the nozzle G1 of the fuel supply gun G to seal the gap, whereby the liquid trap between the reverse flow preventing valve 62 and the pressing plate 64 can be used as a liquid seal even in the vicinity of the fuel supply port 41 by sealing the gap by the seal member 65 which is pushed by the liquid surface and hence is collapsed.

Since the seal member 65 is brought into tight contact with the nozzle G1 by being collapsed by the liquid surface at the time of fuel supply to prevent the sliding contact between the seal member 65 and the nozzle G1 when the nozzle G1 is inserted or pulled out, the sealing property of the seal member 65 can be prevented from being affected by the inserting and pulling-out operation and the sealing property of the seal member 65 can be ensured.

Since the fuel supply gun insertion hole 65A of the seal member 65 is formed to have a diameter larger than that of the fuel supply gun insertion hole 63A of the positioning plate 63, sliding contact of the fuel supply gun G with respect to the seal member 65 at the time of the inserting and pulling-out operation of the fuel supply gun G can be prevented, and the sealing property of the seal member 65 can be ensured.

The width between the positioning plate 63 and the pressing plate 64 is formed into a tapered shape so as to widen toward the fuel supply gun insertion holes 63A, 64A, and the seal member 65 is formed to be thick along the tapered shape, and hence sealing is achieved by the tapered shape by pushing the seal member 65 out toward the fuel supply gun G, so that the sealing property can further be improved.

In addition, since the seal member 65 has a sponge form and the pressing plate 64 has the through hole 64B which penetrates in the vertical direction separately from the fuel supply gun insertion hole 64A, so that the fuel flows from the through hole 64B toward the seal member 65 and the fuel is contained in the seal member 65 of a sponge form, whereby the sealing property can further be improved.

Still further, since the stopper 66 is arranged so that the automatic stop detecting unit G2 of the fuel supply gun G is located above the positioning plate 63 when the fuel supply gun G is inserted, the automatic stop detecting unit G2 can be activated even with a configuration in which the liquid seal is formed below the positioning plate 63. Also, even when there arises a problem in the seal member 65 and the fuel is leaked up, the fuel supply can be stopped by the automatic stop detecting unit G2 and the flow-out of the fuel to the outside can be prevented.

Also, there are provided the cut valve 56 configured to close the charge path 52 in the full tank condition, the fuel return pipe 73 configured to communicate the interior of the fuel tank 24 and the fuel supply pipe 61 above the positioning plate 63, and the return pipe opening and closing valve 74 arranged in the fuel return pipe 73 in the fuel tank 24, and the return pipe opening and closing valve 74 opens in the full tank condition and feeds the fuel to the automatic stop detecting unit G2 above the positioning plate 63. Therefore, even with a configuration in which the liquid surface cannot be viewed due to the presence of the liquid seal, the fuel is fed from the fuel return pipe 73 to the automatic stop detecting unit G2 in the full tank condition and hence the fuel supply can be stopped automatically in the full tank condition.

The first embodiment shows only one embodiment of the present invention, and the present invention is not limited to the first embodiment.

In the first embodiment, the fuel supply gun insertion hole 65A of the seal member 65 has been described to be formed to have a diameter larger than that of the fuel supply gun insertion hole 63A of the positioning plate 63. However, the present invention is not limited thereto and, for example, the fuel supply gun insertion hole 65A may be formed to have a diameter which is the same as that of the fuel supply gun insertion hole 63A of the positioning plate 63. In the configuration having the same diameter as well, the sliding contact of the fuel supply gun G with respect to the fuel supply gun insertion hole 65A can be prevented.

### Second Embodiment

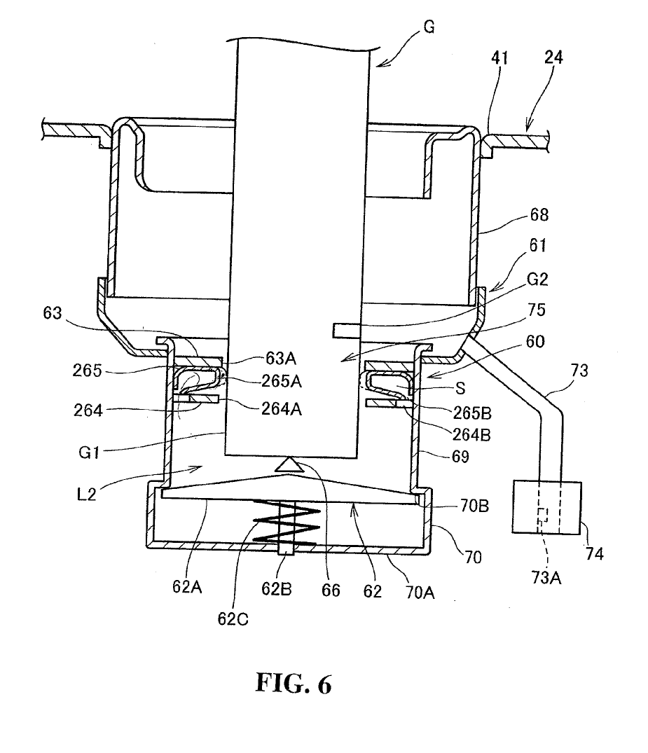

Referring now to FIG. 6, a second embodiment of the present invention will be described. In the second embodiment, portions configured in the same manner as those in the first embodiment are designated by same reference numerals and descriptions thereof are omitted.

In the description of the first embodiment, the seal member 65 having a sponge form is collapsed in the vertical direction between the pressing plate 64 and the positioning plate 63, and protrudes toward the fuel supply gun insertion hole 65A to achieve sealing. However, the second embodiment is different from the first embodiment in that fuel enters a bag-shaped seal member 265 and the seal member 265 protrudes to achieve sealing.

FIG. 6 is a cross-sectional view showing a configuration of a seal mechanism 260 according to the second embodiment.

The seal mechanism 260 includes the fuel supply pipe 61, the reverse flow preventing valve 62, the positioning plate 63, a lower plate 264 provided in the fuel supply pipe 61 between the positioning plate 63 and the reverse flow preventing valve 62, the seal member 265 clamped between the positioning plate 63 and the lower plate 264, the stopper 66 arranged between the lower plate 264 and the reverse flow preventing valve 62, the fuel return pipe 73, and the return pipe opening and closing valve 74.

The lower plate 264 is a disk-shaped member to be fixed below the positioning plate 63 in the lower fuel supply pipe 69, and has a fuel supply gun insertion hole 264A which allows insertion of the nozzle G1 at a center portion thereof. The lower plate 264 includes a plurality of communicating holes 264B (communicating portions) penetrating through the lower plate 264 in the thickness direction. The communicating holes 264B are arranged on the side of an outer peripheral portion of the lower plate 264, and are located in the proximity to an inner peripheral surface of the lower fuel supply pipe 69.

A space between the lower plate 264 and the reverse flow preventing valve 62 in the lower fuel supply pipe 69 is a liquid seal chamber L2 in which a liquid seal (liquid trap) is formed by the fuel flowing from the nozzle G1 trapped temporarily therein. The urging force of the valve spring 62C or the shape of the valve body 62A are set so that the reverse flow preventing valve 62 assumes the valve opening which forms the liquid seal in the liquid seal chamber L2 at the time of fuel supply.

The seal member 265 is a bag-shaped member formed into an annular shape which surrounds the nozzle G1 from the outer peripheral side, is clamped between the positioning plate 63 and the lower plate 264, and has a fuel supply gun insertion hole 265A which allows insertion of the nozzle G1 at a center portion thereof. The seal member 265 includes an opening portion 265B which communicates with a bag-shaped internal space S in a lower portion thereof, and the opening portion 265B is connected to the communicating holes 264B of the lower plate 264 and communicates with the liquid seal chamber L2.

The seal member 265 connected to the outer peripheral side of the lower plate 264 via the communicating holes 264B extends toward the fuel supply gun insertion hole 63A so as to extend along a lower surface of the positioning plate 63, and the diameter of an inner peripheral surface which constitutes the fuel supply gun insertion hole 265A is formed to have a diameter larger than that of the fuel supply gun insertion hole 63A of the positioning plate 63. Therefore, the nozzle G1 is prevented from coming into sliding contact with the fuel supply gun insertion hole 265A, so that the sealing property can be improved.

The seal member 265 is formed of a resilient film such as a balloon. When the fuel enters the internal space S through the communicating holes 264B and the opening portion 265B, the seal member 265 protrudes radially inward toward the nozzle G1, and the inner peripheral surface which constitutes the fuel supply gun insertion hole 265A comes into tight contact with the nozzle G1.

The nozzle G1 is inserted downward while being positioned in the radial direction by the positioning plate 63 in association with the fuel supply, and the distal end thereof is brought into abutment with the stopper 66, whereby the position in the vertical direction is controlled. In this state, the automatic stop detecting unit G2 is positioned on the lower portion of the upper fuel supply pipe 68 above the positioning plate 63.

When the fuel supply from the nozzle G1 is started, the reverse flow preventing valve 62 is opened by a predetermined opening by the pressure of the fuel supply from the nozzle G1, and the supplied fuel forms a liquid seal by temporarily trapped in the liquid seal chamber L2 and is flowed into the fuel tank 24. More specifically, the supplied fuel reaches a lower surface of the lower plate 264 in the liquid seal chamber L2, flows into the internal space S of the seal member 265 through the communicating holes 264B. Consequently, the seal member 265 is deformed and protruded toward the nozzle G1 by the pressure of the fuel supply as indicated by a double-dashed chain line in FIG. 6, and an inner peripheral surface of the fuel supply gun insertion hole 265A comes into tight contact with the outer peripheral surface of the nozzle G1, so that the gap between the nozzle G1 and the fuel supply gun insertion hole 265A is sealed. The evaporative fuel generated at the time of fuel supply flows to the canister 51 through the cut valve 56 (FIG. 3) and the charge path 52 and is adsorbed.

In this manner, the liquid seal is formed in the liquid seal chamber L2 in association with the start of the fuel supply, and an upper portion of the liquid seal chamber L2 is sealed by the seal member 265 which protrudes by the pressure caused by the inflow of the fuel, so that the liquid seal can be formed even in the vicinity of the fuel supply port 41.

In the full tank condition, the fuel supplied from the fuel return pipe 73 reaches the automatic stop detecting unit G2, so that the fuel supply is automatically stopped. When the fuel supply is stopped, the deformation of the seal member 265 is released in association with the outflow of the fuel from the internal space S, and the diameter of the fuel supply gun insertion hole 265A becomes larger than that of the fuel supply gun insertion hole 63A. Therefore, sliding contact of the nozzle G1 with the fuel supply gun insertion hole 265A of the seal member 265 when pulling out the nozzle G1 can be prevented.

As described thus far, according to the second embodiment of the present invention, there are provided the reverse flow preventing valve 62 which allows the opening of the fuel supply pipe 61, which is a cylindrical portion extending into the fuel tank 24, on the inside of the tank and configured to allow the fuel to flow in the fuel supply direction, the positioning plate 63 provided at an opening of the fuel supply pipe 61 on the side of the fuel supply port 41 and having the fuel supply gun insertion hole 63A, the lower plate 264 fixed on the fuel supply pipe 61 between the positioning plate 63 and the reverse flow preventing valve 62 and having the fuel supply gun insertion hole 264A, the bag-shaped seal member 265 clamped between the positioning plate 63 and the lower plate 264 and communicating with the liquid seal chamber L2 by the communicating holes 264B, and the stopper 66 arranged between the lower plate 264 and the reverse flow preventing valve 62 and controls the amount of insertion of the fuel supply gun G and, when the fuel supply is started, the reverse flow preventing valve 62 is configured to be set opened so as to form the liquid trap in the liquid seal chamber L2 between the reverse flow preventing valve 62 and the lower plate 264, and when the liquid surface reaches the lower plate 264, the fuel enters the seal member 265 the communicating holes 264B so that the seal member 265 protrudes toward the fuel supply gun insertion holes 63A, 264A and is brought into tight contact with the nozzle G1 of the fuel supply gun G to seal the gap, whereby the liquid trap between the reverse flow preventing valve 62 and the lower plate 264 can be used as a liquid seal even in the vicinity of the fuel supply port 41 by sealing the gap by the seal member 265 which is protruded by the entry of the fuel reaching the lower plate 264.

Also, since the seal member 265 is brought into tight contact with the fuel supply gun G by the entry of the fuel at the time of fuel supply, and the seal member 265 and the fuel supply gun G do not come into sliding contact with each other when inserting or pulling out the fuel supply gun G, the sealing property of the seal member 265 can be prevented from being affected by the inserting and pulling-out operation, so that the sealing property of the seal member 265 can be ensured.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An evaporative fuel treatment apparatus for a vehicle including an internal combustion engine, a fuel tank configured to store fuel, an evaporative fuel storage container filled with adsorbent such as activated charcoal in the interior thereof and configured to adsorb and store the evaporative fuel therein, a charge path configured to communicate the fuel tank and the evaporative fuel storage container, a purge path configured to communicate the evaporative fuel storage container and an air-intake system of the internal combustion engine and feed the evaporative fuel adsorbed in the evaporative fuel storage container to the air-intake system by depression at engine manifold of the internal combustion engine, an atmospheric air opening path configured to communicate the evaporative fuel storage container and the outside, a fuel supply port, and a fuel supply pipe which is a cylindrical portion extending from the fuel supply port into the fuel tank, comprising:
a reverse flow preventing valve provided at an opening of the fuel supply pipe on the inside of the tank and being a one-way valve which allows the fuel to flow in the fuel supply direction;
a positioning plate provided at an opening of the fuel supply pipe on a side of the fuel supply port and having a fuel supply gun insertion hole;
a pressing plate slidably mounted on the fuel supply pipe between the positioning plate and the reverse flow preventing valve, and having a fuel supply gun insertion hole;
a seal member clamped between the positioning plate and the pressing plate and having resiliency; and
a stopper arranged between the pressing plate and the reverse flow preventing valve and configured to control the amount of insertion of the fuel supply gun,
wherein the reverse flow preventing valve is set to be opened so as to form a liquid trap between the reverse flow preventing valve and the pressing plate when the fuel supply is started, and
when the liquid surface reaches the pressing plate, the fuel pushes the pressing plate upward to collapse the seal member in a vertical direction, and the seal member is protruded toward the fuel supply gun insertion hole and is brought into tight contact with the fuel supply gun to seal a gap.

2. The evaporative fuel treatment apparatus for a vehicle according to claim 1, wherein a fuel supply gun insertion hole of the seal member is formed to have a diameter equal to or larger than the fuel supply gun insertion hole of the positioning plate.

3. The evaporative fuel treatment apparatus for a vehicle according to claim 1, wherein a width between the positioning plate and the pressing plate is formed into a tapered shape so as to widen toward the fuel supply gun insertion holes, and the seal member is formed to be thick along the tapered shape.

4. The evaporative fuel treatment apparatus for a vehicle according to claim 2, wherein a width between the positioning plate and the pressing plate is formed into a tapered shape so as to widen toward the fuel supply gun insertion holes, and the seal member is formed to be thick along the tapered shape.

5. The evaporative fuel treatment apparatus for a vehicle according to claim 1, wherein the seal member has a sponge form, and the pressing plate includes a through hole which penetrates in the vertical direction separately from the fuel supply gun insertion hole.

6. The evaporative fuel treatment apparatus for a vehicle according to claim 2, wherein the seal member has a sponge form, and the pressing plate includes a through hole which penetrates in the vertical direction separately from the fuel supply gun insertion hole.

7. The evaporative fuel treatment apparatus for a vehicle according to claim 3, wherein the seal member has a sponge form, and the pressing plate includes a through hole which penetrates in the vertical direction separately from the fuel supply gun insertion hole.

8. The evaporative fuel treatment apparatus for a vehicle according to claim 1, wherein the fuel supply gun includes an automatic stop detecting unit which is a pressure sensing hole, and the stopper is arranged so that the automatic stop detecting unit is located above the positioning plate when the fuel supply gun is inserted.

9. The evaporative fuel treatment apparatus for a vehicle according to claim 2, wherein the fuel supply gun includes an automatic stop detecting unit which is a pressure sensing hole, and the stopper is arranged so that the automatic stop detecting unit is located above the positioning plate when the fuel supply gun is inserted.

10. The evaporative fuel treatment apparatus for a vehicle according to claim 3, wherein the fuel supply gun includes an automatic stop detecting unit which is a pressure sensing hole, and the stopper is arranged so that the automatic stop detecting unit is located above the positioning plate when the fuel supply gun is inserted.

11. The evaporative fuel treatment apparatus for a vehicle according to claim 4, wherein the fuel supply gun includes an automatic stop detecting unit which is a pressure sensing hole, and the stopper is arranged so that the automatic stop detecting unit is located above the positioning plate when the fuel supply gun is inserted.

12. The evaporative fuel treatment apparatus for a vehicle according to claim 1, comprising:
a cut valve provided in a charge path in the fuel tank and configured to close the charge path in a full tank condition,
a fuel return pipe configured to communicate the interior of the fuel tank and the fuel supply pipe above the positioning plate, and
a return pipe opening and closing valve which is a float valve to be arranged in the fuel return pipe in the fuel tank,
wherein the return pipe opening and closing valve is opened in the full tank condition to feed the fuel to the automatic stop portion above the positioning plate.

13. The evaporative fuel treatment apparatus for a vehicle according to claim 2, comprising:
a cut valve provided in a charge path in the fuel tank and configured to close the charge path in a full tank condition,
a fuel return pipe configured to communicate the interior of the fuel tank and the fuel supply pipe above the positioning plate, and
a return pipe opening and closing valve which is a float valve to be arranged in the fuel return pipe in the fuel tank,
wherein the return pipe opening and closing valve is opened in the full tank condition to feed the fuel to the automatic stop portion above the positioning plate.

14. The evaporative fuel treatment apparatus for a vehicle according to claim 3, comprising:
a cut valve provided in a charge path in the fuel tank and configured to close the charge path in a full tank condition,
a fuel return pipe configured to communicate the interior of the fuel tank and the fuel supply pipe above the positioning plate, and
a return pipe opening and closing valve which is a float valve to be arranged in the fuel return pipe in the fuel tank,
wherein the return pipe opening and closing valve is opened in the full tank condition to feed the fuel to the automatic stop portion above the positioning plate.

15. The evaporative fuel treatment apparatus for a vehicle according to claim 4, comprising:
a cut valve provided in a charge path in the fuel tank and configured to close the charge path in a full tank condition,
a fuel return pipe configured to communicate the interior of the fuel tank and the fuel supply pipe above the positioning plate, and
a return pipe opening and closing valve which is a float valve to be arranged in the fuel return pipe in the fuel tank,
wherein the return pipe opening and closing valve is opened in the full tank condition to feed the fuel to the automatic stop portion above the positioning plate.

16. The evaporative fuel treatment apparatus for a vehicle according to claim 5, comprising:
a cut valve provided in a charge path in the fuel tank and configured to close the charge path in a full tank condition,
a fuel return pipe configured to communicate the interior of the fuel tank and the fuel supply pipe above the positioning plate, and
a return pipe opening and closing valve which is a float valve to be arranged in the fuel return pipe in the fuel tank,
wherein the return pipe opening and closing valve is opened in the full tank condition to feed the fuel to the automatic stop portion above the positioning plate.

17. An evaporative fuel treatment apparatus for a vehicle including an internal combustion engine, a fuel tank configured to store fuel, an evaporative fuel storage container filled with adsorbent such as activated charcoal in the interior thereof and configured to adsorb and store the evaporative fuel therein, a charge path configured to communicate the fuel tank and the evaporative fuel storage container, a purge path configured to communicate the evaporative fuel storage container and an air-intake system of the internal combustion engine and feed the evaporative fuel adsorbed in the evaporative fuel storage container to the air-intake system by depression at engine manifold of the internal combustion engine, an atmospheric air opening path configured to communicate the evaporative fuel storage container and the outside, a fuel supply port, and a fuel supply pipe which is a cylindrical portion extending from the fuel supply port into the fuel tank, comprising:
a reverse flow preventing valve provided at an opening of the fuel supply pipe on the inside of the tank and being a one-way valve which allows the fuel to flow in the fuel supply direction;
a positioning plate provided at an opening of the fuel supply pipe on a side of the fuel supply port and having a fuel supply gun insertion hole;
a lower plate fixed to the fuel supply pipe between the positioning plate and the reverse flow preventing valve and having a fuel supply gun insertion hole;
a bag-shaped seal member clamped between the positioning plate and the lower plate and configured to communicate with a liquid seal chamber by a communicating portion; and
a stopper arranged between the lower plate and the reverse flow preventing valve and configured to control the amount of insertion of the fuel supply gun,
wherein the reverse flow preventing valve is set to be opened so as to form a liquid trap in the liquid seal chamber between the reverse flow preventing valve and the lower plate when the fuel supply is started, and
when the liquid surface reaches the lower plate, the fuel enters the seal member from the communicating portion, and the seal member is protruded toward the fuel supply gun insertion holes and is brought into tight contact with the fuel supply gun to seal a gap.

18. The evaporative fuel treatment apparatus for a vehicle according to claim 17, wherein the fuel supply gun includes an automatic stop detecting unit which is a pressure sensing hole, and the stopper is arranged so that the automatic stop detecting unit is located above the positioning plate when the fuel supply gun is inserted.

19. The evaporative fuel treatment apparatus for a vehicle according to claim 17, comprising:
a cut valve provided in a charge path in the fuel tank and configured to close the charge path in a full tank condition,
a fuel return pipe configured to communicate the interior of the fuel tank and the fuel supply pipe above the positioning plate, and
a return pipe opening and closing valve which is a float valve to be arranged in the fuel return pipe in the fuel tank,
wherein the return pipe opening and closing valve is opened in the full tank condition to feed the fuel to the automatic stop portion above the positioning plate.

20. The evaporative fuel treatment apparatus for a vehicle according to claim 18, comprising:
a cut valve provided in a charge path in the fuel tank and configured to close the charge path in a full tank condition,
a fuel return pipe configured to communicate the interior of the fuel tank and the fuel supply pipe above the positioning plate, and
a return pipe opening and closing valve which is a float valve to be arranged in the fuel return pipe in the fuel tank,
wherein the return pipe opening and closing valve is opened in the full tank condition to feed the fuel to the automatic stop portion above the positioning plate.
